(19) United States
(12) Patent Application Publication
(10) Pub. No.: US 2011/0099832 A1
(43) Pub. Date: May 5, 2011

(54) EAR DRYER

(76) Inventor: Henry B. Bikhazi, Newport Beach, CA (US)

(21) Appl. No.: 12/610,924

(22) Filed: Nov. 2, 2009

(51) Int. Cl. F26B 25/00

(52) U.S. Cl. 34/104

(57) ABSTRACT

Provided is an ear drying device includes an adapter sleeve defining an outer surface and an inner surface defining a fluid chamber. A fluid flow is generated through the fluid chamber when the adapter sleeve is engaged with a hair dryer. An exhaust vent extends from the outer surface to the inner surface. An inlet vent extends from the outer surface to the inner surface and is spaced axially from the exhaust vent. The adapter sleeve is sized and configured to draw ambient air through the inlet vent into the fluid chamber in response to fluid flowing through the fluid chamber. A diffuser is disposable within the adapter sleeve and is sized and configured to direct a portion of the fluid flow toward the exhaust vent. An ear piece is engageable with the adapter sleeve and is configured to direct fluid toward the user's ear.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to an ear drying device, and more specifically to an ear drying device configured for use with a hair dryer to dry a user's ear.

An individual's ear is a delicate and complex structure which is generally comprised of three sections, namely, the outer ear, the middle ear and the inner ear. The outer ear (generally referred to as the ear canal) is the short passageway from the outside of the ear to the ear drum. The length of the outer ear is approximately one inch in most human beings.

Water may accumulate within the ear while swimming, showering, or while participating in other water based activities. Moisture buildup within the outer ear may lead to infection. For instance, the infection may be caused by swimming in bacteria-infected waters. In addition, moisture buildup within the outer ear may create a moist environment which bacteria and fungi may be attracted to for growth. Infection in the outer ear may cause swelling, redness, heat, pain, and discharge, which tends to lead to discomfort. The swelling and discharge may additionally block the ear canal and cause temporary deafness. In addition to infection, moisture buildup may cause imbalance. In order to reduce the volume of moisture which enters the ear, an individual may wear ear plugs to seal the inner ear. However, ear plugs are typically not 100% effective, as moisture tends to seep into the ear, despite the presence of ear plugs. As such, it is desirable to remove moisture from the ear to reduce the likelihood of infection, imbalance, and discomfort.

A common technique for removing moisture from an individual's ear is to carefully insert a cotton-tipped swab slightly into the ear canal to absorb moisture accumulated in the ear canal. However, due to the delicate nature of the ear, the cotton-tipped swab can only slightly advance into the ear, which limits the amount of moisture the swab can absorb. Moisture present deep within the ear canal may not be absorbed by the swab, thereby making this technique inefficient.

Another drying technique is to use a hair dryer to blow air into the ear. The delicate structure of the ear generally requires that the hair dryer be held a safe distance from the ear (typically 18 to 20 inches). The components of the ear have a relatively low threshold for pressure and temperature fluctuations. Therefore, by holding the hair dryer away from the ear, the pressure applied by the air exhausted by the hair dryer is reduced, and the temperature of the air is cooled. However, the small opening of the ear makes it difficult to effectively direct air from the hair dryer into the ear to completely remove moisture from the ear.

In addition, several specially designed ear drying apparatus have been developed which are capable of blowing air into the ear canal through an adapter which fits into the opening of the outer ear. However, such devices tend to be complicated and expensive to manufacture.

As is apparent from the foregoing, there exists a need in the art for a simple, safe, and efficient device for removing moisture from an ear. Various aspects of the present invention address these particular needs, as will be discussed in more detail below.

### BRIEF SUMMARY

Provided is an ear drying device for use with a conventional hair dryer. The ear drying device is attachable to the hair dryer to adapt the fluid output of the hair dryer to safely and quickly dry the ear of a user. In particular, the ear drying device may reduce the velocity of the fluid output of the hair dryer, thereby reducing the fluid pressure exerted on the user's ear. Furthermore, the ear drying device may also reduce the temperature of the fluid output to a temperature that is safe for the user's ear.

One embodiment of the ear drying device includes an adapter sleeve defining a longitudinal sleeve axis. The adapter sleeve is configured to be engagable with the hair dryer to fluidly connect the adapter sleeve to the hair dryer. The adapter sleeve includes an outer surface and an inner surface defining a fluid chamber. The fluid chamber extends between an adapter proximal opening and an adapter distal opening. A fluid flow is generated through the fluid chamber from the adapter proximal opening toward the adapter distal opening when the adapter sleeve is engaged with the hair dryer and the hair dryer is outputting a fluid output. An exhaust vent extends radially through the adapter sleeve from the outer surface to the inner surface. An inlet vent extends radially through the adapter sleeve from the outer surface to the inner surface and is spaced axially from the exhaust vent. The adapter sleeve is sized and configured to draw ambient air through the inlet vent into the fluid chamber in response to fluid flowing through the fluid chamber. The ambient air is external to the adapter sleeve, and is separate from the fluid flow generated by the hair dryer. The ear drying device also includes a diffuser disposable within the adapter sleeve. The diffuser is sized and configured to direct a first portion of the fluid flow toward the exhaust vent and a second portion of the fluid flow toward the adapter distal opening. An ear piece is engageable with the adapter sleeve and includes an upstream end portion, a downstream end portion, and a fluid passageway extending between the upstream end portion and the downstream end portion. The upstream end portion is engageable with the adapter sleeve to fluidly connect the fluid chamber with the fluid passageway. The downstream end portion is configured to be disposed adjacent the ear of the user.

The ear drying may also include a flow restrictor disposable within the adapter sleeve. The flow restrictor may be sized and configured to reduce the velocity of fluid flow through the fluid chamber. The flow restrictor may also be configured to absorb heat from the fluid flow to reduce the temperature of the fluid flow.

It is also contemplated that other embodiments of the invention may include an adapter sleeve having an adapter proximal end portion engageable with the hair dryer, an adapter distal end portion, and a diffuser portion disposed between the adapter proximal end portion and the adapter distal end portion. The diffuser portion includes an exhaust vent formed therein and a rotational element being rotatable about a sleeve axis. The rotational element is sized and configured to direct a first portion of the fluid flow toward the exhaust vent and a second portion of the fluid flow toward the adapter distal end portion as the rotational element rotates.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is upper perspective view of the ear drying device engaged with a hair dryer, the ear drying device having an end portion inserted into a user's ear;

FIG. 2 is an upper perspective exploded view of the ear drying device;

FIG. 3 is a cross sectional view of the ear drying device illustrating a fluid flow through the ear drying device;

FIG. 4 is an end view of the ear drying device depicted in FIG. 3; and

FIG. 5 is a second embodiment of the ear drying device.

### DETAILED DESCRIPTION

Referring now to the drawings, wherein the showings are for purposes of illustrating a preferred embodiment of the present invention only, and not for purposes of limiting the same, there is depicted an ear drying device 10 configured for use with a hair dryer 12 for safely and effectively drying a user's ear 14. The ear drying device 10 is configured to receive the air exhausted by the hair dryer 12 and to condition the air for safely and effectively drying the user's ear 14. In particular, the ear drying device 10 may be used to decrease the velocity and temperature of the air exhausted by the hair dryer 12 to safe, yet effective levels, for drying the ear 14 of the user. As used herein, the word “air” refers to any fluid which may be exhausted by the hair dryer 12. Furthermore, the term “hair dryer” may refer to any device configured to blow air or to generate an air flow.

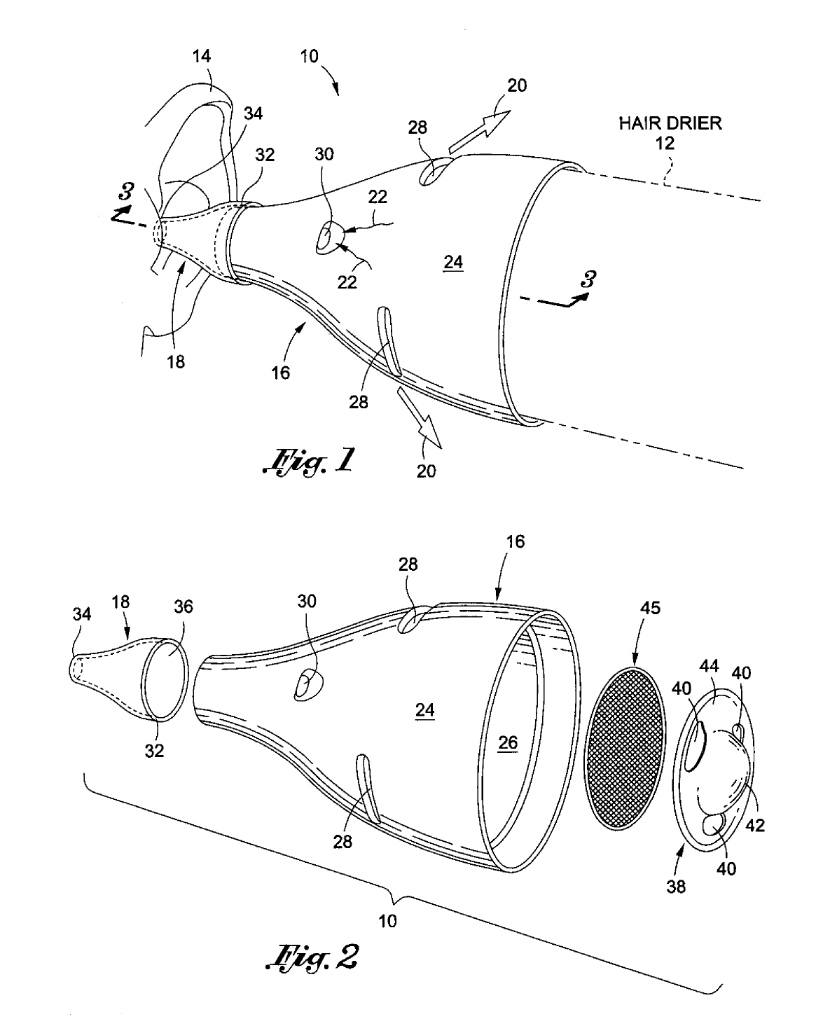

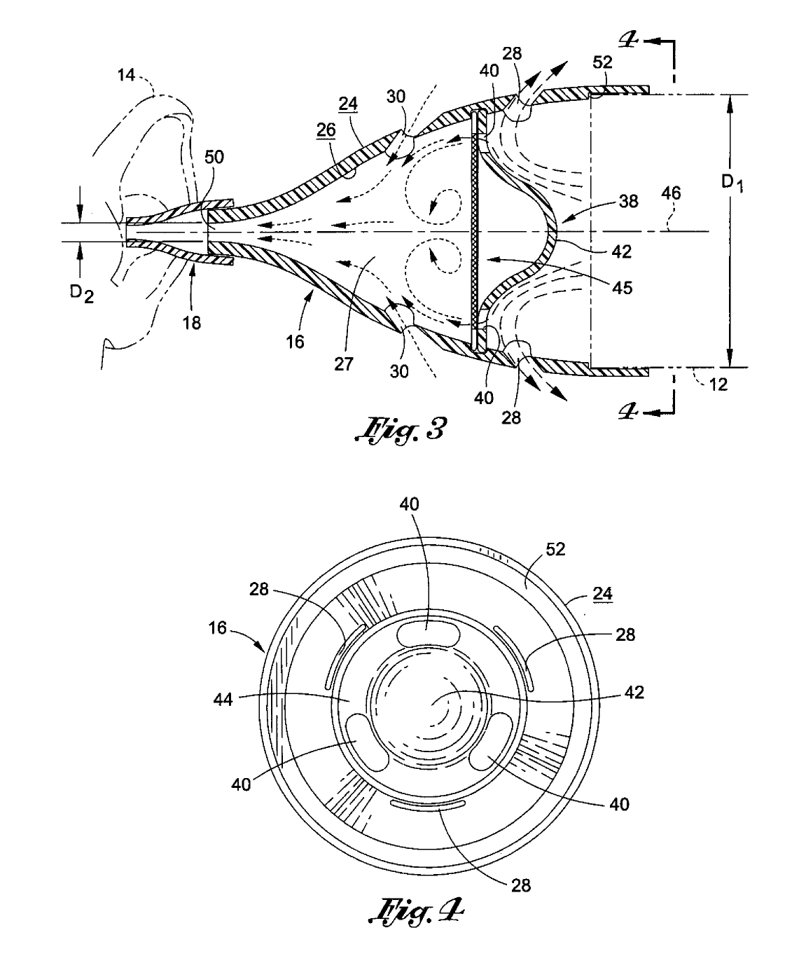

Referring now to FIG. 1, the ear drying device 10 includes an adapter sleeve 16 and an ear piece 18. The adapter sleeve 16 is sized and to be engageable with the output nozzle of a conventional hair dryer 12. The adapter sleeve 16 decreases the velocity and temperature of the air exhausted from the hair dryer 12 by directing a portion of the air flow out of the sleeve 16 (indicated by arrows 20), and drawing in cooler ambient air from outside of the sleeve 16 (indicated by arrows 22). The adapter sleeve 16 includes an outer surface 24 and an inner surface 26 (See FIG. 2). The inner surface 26 defines a fluid chamber 27 (See FIGS. 2 and 3) through which the air flow may pass through. The adapter sleeve 16 includes one or more exhaust vents 28 extending radially from the outer surface 24 to the inner surface 26. The exhaust vents 28 are sized and positioned to allow air to exit the adapter sleeve 16. The adapter sleeve 16 may further include one or more inlet vents 30 extending radially through the sleeve 16 from the outer surface 24 to the inner surface 26. The inlet vents 30 are sized and positioned to allow ambient air to enter the adapter sleeve 16. The ambient air is external to the adapter sleeve 16 and is separate from the fluid flow generated by the hair dyer 12. The air flow through the adapter sleeve 16 may draw ambient air through the inlet vents 30 in accordance with the Venturi effect, as described in more detail below.

The ear piece 18 is engageable with the adapter sleeve 16 to fluidly communicate air from the adapter sleeve 16 to the user's ear 14. The ear piece 18 includes an upstream end portion 32, a downstream end portion 34, and a fluid passageway 36 (See FIG. 2) extending therebetween. The upstream end portion 32 is configured to engage with the adapter sleeve 16 to fluidly communicate the ear piece 18 and the adapter sleeve 16. The downstream end portion 34 is configured to be safely advanced into a user's ear 14. In this manner, diameter of the ear piece 18 increases from the downstream end portion 34 toward the upstream end portion 32 to prevent the ear piece 18 from being inserted too far into the user's ear 14.

The ear drying device 10 may include additional components or features for conditioning the air flow to safely and effectively dry the user's ear 14. Referring now specifically to the embodiment depicted in FIG. 2, the ear drying device 10 includes a diffuser 38 disposable within the adapter sleeve 16. The diffuser 38 is sized and configured to be positioned within the air flow to direct a first portion of the air flow out of the adapter sleeve 16 through the exhaust vents 28, while a second portion of the air flow continues to flow through the adapter sleeve 16. To this end, the diffuser 38 may extend substantially across the opening defined by the adapter sleeve 16. The diffuser 38 may also extend substantially perpendicularly relative to the direction of air flow.

The diffuser 38 may include one or more apertures 40 formed therein to allow a portion of the air flow to pass through the diffuser 38. In the embodiment depicted in FIG. 2, the diffuser 38 includes three openings 40, however, it is understood that other embodiments of the diffuser 38 may include fewer than three openings 38, or more than three openings 38. The size, shape, and placement of the openings 38 may also vary without departing from the spirit and scope of the present invention.

The diffuser 38 may further include a curved middle portion 42 for separating the air flow and directing the air flow radially outwardly. The curved middle portion 42 may define a semi-spherical shape, as illustrated in FIG. 2. The curved middle portion 42 may be circumscribed by a flange 44 for restricting air flow from passing the diffuser 38. The curved middle portion 42 may extend upstream relative to the flange 44 when placed in the adapter sleeve 16 (See FIG. 3).

The ear drying device 10 may further include a flow restrictor 45 sized and configured to reduce the velocity and temperature of the air flow flowing through the adapter sleeve 16. The flow restrictor 45 may be sized and configured to serve as a heat sink for air passing therethrough. In other words, heat may be transferred from the air flow to the flow restrictor 45 to reduce the temperature of the air passing through the flow restrictor 45. In this manner, the flow restrictor 45 may be configured to increase the contact area with the fluid flow to facilitate heat transfer from the fluid flow to the flow restrictor 45.

Like the diffuser 38, the flow restrictor 45 may extend substantially across the opening defined by the adapter sleeve 16, and substantially perpendicularly relative to the direction of air flow. The flow restrictor 45 may additionally serve as a filter to reduce the likelihood that foreign objects are inadvertently blown into the user's ear 14.

Referring now to FIG. 3, there is shown a cross sectional view of the ear drying device 10 defining a longitudinal axis 46, wherein the ear drying device 10 is engaged with the hair dryer 12. The adapter sleeve 16 defines an adapter proximal opening 48 into which the hair dryer 12 may be inserted. Air is exhausted by the hair dryer 12 and passes through the fluid chamber 27 from the adapter proximal opening 48 toward an adapter distal opening 50.

As the air enters the adapter sleeve 16 it is directed toward the diffuser 38. The diffuser 38 separates the air flow and directs a first portion of the flow radially outwardly (away from the longitudinal axis 46). The first portion of the air flow passes through the exhaust vents 28, while the second portion passes through apertures 40 formed within the diffuser 38. This reduces the overall volume of air exhausted from the hair dryer 12 passing through the adapter sleeve 16, which helps to reduce the velocity and temperature of the air entering the user's ear 14. The portion of air flow passing through the apertures 40 subsequently passes through the flow restrictor 45 to further reduce the velocity and temperature of the air flow. The velocity of the air flow may be reduced by creating fluid drag. The temperature of the air flow may be reduced via heat transfer from the air flow to the flow restrictor 45.

After the air passes through the flow restrictor 45, it continues toward the distal opening 50. The shape of the inner surface 26 funnels the air toward the distal opening 50. In this respect, the inner surface 26 may define a first diameter D1 at the proximal opening 48 and a second diameter D2 at the distal opening 50, wherein the first diameter D1 is larger than the second diameter D2. The transition from the first diameter D1 to the second diameter D2 may be smooth and gradual, and may define a curved shape.

As the air flows toward the distal opening 50, ambient air from outside the adapter sleeve 16 may be drawn into the fluid chamber 27. The inlet vent 30 may be sized and configured to draw in ambient air in accordance with the Venturi effect. The Venturi effect is a fluid principle which states that a fluid flowing through a restricted passageway results in a reduction in fluid pressure. With regard to the ear drying device 10, the adapter sleeve 16 defines a restricted passageway in a direction from the proximal opening 48 toward the distal opening 50 to produce a reduction in pressure, which results in ambient air being drawn in through the inlet vents 30. It is contemplated that the ambient air will generally be at a temperature which is cooler than the air within the fluid chamber 27. Therefore, in most cases, the ambient air drawn into the fluid chamber 27 cools the overall temperature of the air within the fluid chamber 27.

The mixture of ambient air drawn into the fluid chamber 27 and air already present within the fluid chamber 27 continues toward the distal opening 50. The air flow exits the fluid chamber 27 through the distal opening 50 and enters the ear piece 18. The upstream end portion 32 of the ear piece 18 is detachably engageable with the adapter sleeve 16 to place the ear piece 18 in fluid communication with the adapter sleeve 16. The downstream end portion 34 of the ear piece 18 may be insertable into the user's ear 14 to safely direct the air flow into the user's ear 14 for drying the ear 14. In this regard, the ear piece 18 communicates fluid from the adapter sleeve 16 to the user's ear 14.

The above-described components of the ear dryer 10 may be detachably engaged with each other, or they may be integrated into a single unit. In the case of detachable components, the components may be configured to frictionally engage with each other during use. For instance, the adapter sleeve 16 shown in FIGS. 1-3 is adapted to be disposed over a portion of the hair dryer 12 to circumferentially engage the hair dryer 12 (i.e., the diameter of the adapter sleeve 16 is greater than the diameter of the hair dyer 12). The adapter sleeve 16 may be formed out of a rubber material, silicone material, or similar material known by those skilled in the art to conform to different sized hair dryers 12. The inner surface 26 of the adapter sleeve 16 may define an annular shelf 52 (See FIGS. 2 and 3) to limit insertion of the hair dryer 12 into the adapter sleeve 16. It is also contemplated that in other implementations, the adapter sleeve 16 may be configured to be inserted into the hair dyer 12 for engagement with the hair dryer 12 (i.e., the diameter of the adapter sleeve 16 is less than the diameter of the hair dryer 12).

The diffuser 38 and flow restrictor 45 may be detachably engageable with the adapter sleeve 16. The adapter sleeve 16 may include an annular groove 54 formed within the inner surface 26, wherein the annular groove 54 is sized and configured to engage with the diffuser and the flow restrictor, as illustrated in FIG. 3.

The ear piece 18 may also be configured to be detachably engageable with the adapter sleeve 16. As shown in FIGS. 1-3, the upstream end portion 32 of the ear piece 18 is configured to receive the distal end portion of the adapter sleeve 16 to circumferentially engage the adapter sleeve 16. However, in other embodiments, the ear piece 18 may be sized and configured to fit within the adapter sleeve 16 for engagement therewith.

Turning now to FIG. 5, there is shown a second embodiment of an ear drying device 100. The ear drying device 100 includes an adapter sleeve 102 and an ear piece 104. The adapter sleeve 102 extends along a longitudinal sleeve axis 106 and defines a proximal end portion 108 and a distal end portion 110. The proximal end portion 108 is engageable with the hair dryer 12. Disposed between the proximal end portion 108 and the distal end portion 110 is a diffuser portion 112.

When the adapter sleeve 102 is engaged with the hair dryer 12, a fluid flow may be created through the adapter sleeve 102. The temperature and velocity of the air flowing through the adapter sleeve 102 may be decreased by the diffuser portion 112. To this end, one embodiment of the diffuser portion 112 includes a rotational element 114 and an exhaust vent 116 for directing a portion of the warm air from the hair dryer 12 out of the adapter sleeve 102. The rotational element 114 is rotatable about the sleeve axis 106. As the rotational element 114 rotates, warm air from within the adapter sleeve 102 is exhausted to the ambient environment through the exhaust vents 116.

The rotational element 114 depicted in FIG. 5 is a turbine-type rotational element including a hub 118, an outer ring 120, and a plurality of blades 122 extending radially outwardly from the hub 118 toward the outer ring 120. The blades 122 are configured to direct air out of the adapter sleeve 102 as the hub 118 rotates. The blades 122 may also serve as heat sinks to absorb heat from the air passing through the adapter sleeve 102. A plurality of bearings 124 may be disposed between the outer ring 120 and a diffuser wall 126 to allow the outer ring 120, blades 122, and hub 118 to rotate relative to the diffuser wall 126.

The hub 118 may be shaped to direct the airflow radially outwardly toward the blades 122 and the exhaust vent 116. In other words, the hub 118 may include a rounded middle portion 128 which extends into the fluid flow. The rounded middle portion 128 may separate the fluid flow and direct the fluid flow radially outwardly toward the exhaust vents 116.

The ear drying device 100 may additionally include a flow restrictor 132, as described in more detail above, for decreasing the temperature and velocity of the fluid flow through the ear drying device 100.

The proximal end portion 108 of the adapter sleeve 102 is configured to engage with the hair dryer 12. One embodiment of the proximal end portion 108 includes an engagement collar 130 configured to frictionally engage with the hair dryer 12. The engagement collar 130 may be sized to be inserted into the hair dyer 12 for engagement therewith, or alternatively, to fit over the hair dyer 12. Other engagement configurations and devices known by those skilled in the art may also be used to engage the adapter sleeve 102 to the hair dryer 12 without departing from the spirit and scope of the present invention.

The distal end portion 110 receives the cooled and slowed air flow from the diffuser portion 112 and directs the air flow toward the ear piece 104. The air flow then travels through the ear piece 104 and into the user's ear 14.

The distal end portion 110, diffuser portion 116, and proximal end portion 108 may be configured to be detachably engageable with each other. In other embodiments, the distal end portion 110, diffuser portion 116, and proximal end portion 108 are integrally formed into a single unitary structure.

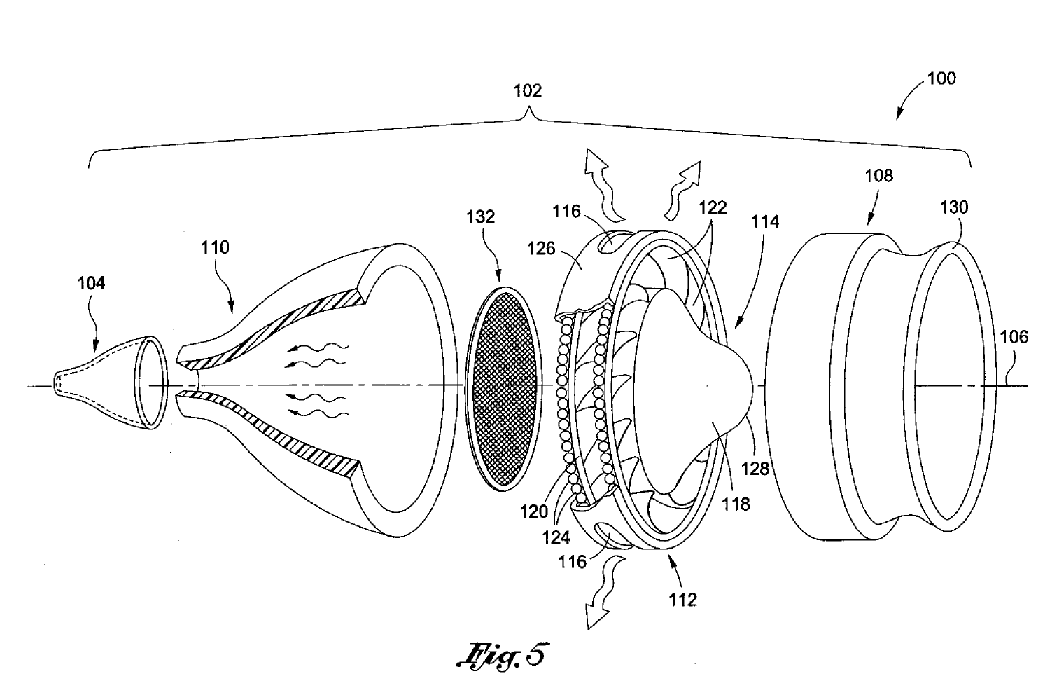

The ear drying device 10 illustrated in FIGS. 1-4, as well as the ear drying device 100 illustrated in FIG. 5, are configured to cool the air flow exhausted from the air dryer 12 to less than 100 degrees Fahrenheit before the air flow enters the user's ear 14 to mitigate damage to the ear 14. The devices 10, 100 may also be configured to dry the user's ear 14 within fifteen seconds. Various embodiments of the devices 10, 100 may also be able to reduce the audible output to less than 60 decibels. Other embodiments of the devices 10, 100, particularly the device 100 including a turbine-type diffuser portion 112 may be configured to create a distinctive sound to indicate that the device 100 is being used.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. An ear drying device for use with a hair dryer for drying an ear of a user, the hair dryer being operative to generate a fluid flow, the ear drying device comprising:
an adapter sleeve configured to be engagable with the hair dryer to fluidly connect the adapter sleeve to the hair dryer, the adapter sleeve having:
an outer surface;
an inner surface defining a fluid chamber extending between an adapter proximal opening and an adapter distal opening, a fluid flow being generated through the fluid chamber from the adapter proximal opening toward the adapter distal opening when the adapter sleeve is engaged with the hair dryer;
an exhaust vent extending radially through the adapter sleeve from the outer surface to the inner surface; and
an inlet vent extending radially through the adapter sleeve from the outer surface to the inner surface, the inlet vent being spaced axially from the exhaust vent, the adapter sleeve being sized and configured to draw ambient air through the inlet vent into the fluid chamber in response to a fluid flow through the fluid chamber, the ambient air being external to the adapter sleeve and separate from the fluid flow generated by the hair dryer;
an ear piece engageable with the adapter sleeve, the ear piece having an upstream end portion, a downstream end portion, and a fluid passageway extending between the upstream end portion and the downstream end portion, the upstream end portion being engageable with the adapter sleeve to fluidly connect the fluid chamber with the fluid passageway, the downstream end portion being configured to be disposed adjacent the ear of the user; and
a diffuser disposable within the adapter sleeve, the diffuser being sized and configured to direct a first portion of the fluid flow toward the exhaust vent and a second portion of the fluid flow toward the adapter distal opening.

2. The ear drying device as recited in claim 1, further comprising a flow restrictor disposable within the adapter sleeve, the flow restrictor being sized and configured to reduce the velocity of fluid flow through the fluid chamber.

3. The ear drying device as recited in claim 2, wherein the flow restrictor is configured to absorb heat from the fluid flow

4. The ear drying device as recited in claim 2, wherein the adapter sleeve defines a longitudinal sleeve axis, the flow restrictor extending across the fluid chamber in a direction substantially orthogonal to the longitudinal sleeve axis.

5. The ear drying device as recited in claim 1, wherein the adapter sleeve defines a longitudinal sleeve axis, the fluid flow entering the fluid chamber in an axial direction relative to the longitudinal sleeve axis, the diffuser being configured to direct fluid radially outwardly toward the exhaust vent.

6. The ear drying device as recited in claim 5, wherein the diffuser includes a semi-spherical flow separator and a deflector extending radially outwardly from the flow separator.

7. The ear drying device as recited in claim 1, wherein the diffuser includes an aperture formed therein to permit fluid to pass through the diffuser.

8. The ear drying device as recited in claim 1, wherein the inner surface defines an inner diameter, the inner diameter decreasing in a direction from the proximal opening toward the distal opening.

9. The ear drying device as recited in claim 1, wherein ambient air is drawn into the fluid chamber through the inlet vent to cool the fluid flow to less than 100 degrees Fahrenheit.

10. The ear drying device as recited in claim 1, wherein the inner sleeve of the adapter sleeve is configured to be circumferentially engagable with the hair dryer.

11. An ear drying device for use with a hair dryer for drying an ear of a user, the hair dryer being operative to generate a fluid flow, the ear drying device comprising:
an adapter sleeve extending along a longitudinal sleeve axis, the adapter sleeve having an adapter proximal end portion engageable with the hair dryer, an adapter distal end portion, and a diffuser portion disposed between the proximal end portion and the distal end portion, a fluid flow passing through the adapter sleeve when the adapter proximal end portion is engaged with the hair dryer, the diffuser portion having an exhaust vent formed therein and a rotational element being rotatable about the sleeve axis, the rotational element being sized and configured to direct a first portion of the fluid flow toward the exhaust vent and a second portion of the fluid flow toward the adapter distal end portion as the rotational element rotates; and
an ear piece engageable with the adapter sleeve, the ear piece having an upstream end portion, a downstream end portion, and a fluid passageway extending between the upstream end portion and the downstream end portion, the upstream end portion being engageable with the adapter sleeve to fluidly connect the adapter sleeve with the fluid passageway, the downstream end portion being configured to be disposed adjacent the ear of the user.

12. The ear drying device as recited in claim 11, wherein the rotational element includes:
an outer ring;
a hub being rotatable relative to the outer ring; and
a plurality of blades extending radially outwardly from the hub toward the outer ring.

13. The ear drying device as recited in claim 12, wherein the hub includes a rounded projection extending away from the plurality of blades, the rounded projection being sized and configured to direct fluid radially outwardly toward the exhaust vent.

14. The ear drying device as recited in claim 11, wherein the proximal end portion includes an inner collar sized and configured to be engageable with the hair dryer.

15. The ear drying device as recited in claim 11, further comprising a flow restrictor disposable within the adapter sleeve, the flow restrictor being sized and configured to reduce the velocity of fluid flow through the adapter sleeve.

16. The ear drying device as recited in claim 11, wherein the rotational element is configured to absorb heat from fluid flow.

17. An ear drying device for use with a hair dryer for drying an ear of a user, the hair dryer being operative to exhaust fluid, the ear drying device comprising:
an adapter sleeve configured to be engagable with the hair dryer to fluidly connect the adapter sleeve to the hair dryer and to direct fluid exhausted from the hair dryer toward the ear of the user, the adapter sleeve having:
an outer surface;
an inner surface defining a fluid chamber extending between an adapter proximal opening and an adapter distal opening, a fluid flow being generated through the fluid chamber from the adapter proximal opening toward the adapter distal opening when the adapter sleeve is engaged with the hair dryer;
an exhaust vent extending radially through the adapter sleeve from the outer surface to the inner surface; and
an inlet vent extending radially through the adapter sleeve from the outer surface to the inner surface, the inlet vent being spaced axially from the exhaust vent, the adapter sleeve being sized and configured to draw ambient air through the inlet vent into the fluid chamber in response to a fluid flow through the fluid chamber, the ambient air being external to the adapter sleeve and separate from the fluid flow generated by the hair dryer; and
a diffuser disposable within the adapter sleeve, the diffuser being sized and configured to direct a first portion of the fluid flow toward the exhaust vent and a second portion of the fluid flow toward the adapter distal opening.

18. The ear drying device as recited in claim 17, further comprising a flow restrictor disposable within the adapter sleeve, the flow restrictor being sized and configured to reduce the velocity of fluid flow through the fluid chamber.

19. The ear drying device as recited in claim 17, wherein the adapter sleeve defines a longitudinal sleeve axis, the fluid flow entering the fluid chamber in an axial direction relative to the longitudinal axis, the diffuser being configured to direct fluid radially outwardly toward the exhaust vent.

20. The ear drying device as recited in claim 19, wherein the diffuser includes a semi-spherical flow separator and a deflector extending radially outwardly from the flow separator.
